(19) United States
(12) Patent Application Publication
(10) Pub. No.: US 2016/0179656 A1
(43) Pub. Date: Jun. 23, 2016

(54) AUTOMATICALLY TESTING FIRMWARE

(71) Applicant: EMC Corporation, Hopkinton, MA (US)

(72) Inventors: Bruce Yunlong Yang, Shanghai (CN); Martin Yang Zhang, Shanghai (CN)

(21) Appl. No.: 14/973,160

(22) Filed: Dec. 17, 2015

(30) Foreign Application Priority Data
Dec. 19, 2014 (CN) 201410813967.1

(51) Int. Cl. G06F 11/36

(52) U.S. Cl. CPC G06F 11/3664; G06F 11/368

(57) ABSTRACT

Embodiments of the present disclosure provide a method and a system for automatically testing firmware by determining a contextual environment where a firmware is located; determining a hardware environment where the firmware is located; and testing the firmware at least partly based on the contextual environment and the hardware environment.

### RELATED APPLICATION

This application claims priority from Chinese Patent Application Number CN201410813967.1 filed on Dec. 19, 2014 entitled “METHOD AND SYSTEM FOR AUTOMATICALLY TESTING FIRMWARE” the content and teachings of which is herein incorporated by reference in its entirety.

### FIELD OF THE INVENTION

Embodiments of the present invention relate to the field of firmware testing.

### BACKGROUND ART

As computer software technologies develop, firmware development and testing may be gaining importance in research. The term “firmware” may generally refer to a type of program stored in a flash memory chip such as Erasable Programmable Read-Only Memory (EPROM) or Electrically Erasable Programmable Read-Only Memory (EEPROM). Usually, such a program may be responsible for relatively basic and fundamental work. For example, a basic input/output system (BIOS) on a computer mainboard may be a firmware. However, as integrated circuit technology develops, a boundary between firmware and ordinary software may no longer be particularly obvious. Hence, a rigid distinction between “firmware” and software may not be performed in text unless otherwise necessary.

Usually, after the completion of a development procedure of firmware, a tester may need to manually test a developed firmware, because a state of the tested system has uncertainty, which may usually cause a test case or step for testing the firmware to be adjusted correspondingly. In case of support lacking from an effective mechanism, such uncertainty may make testing of firmware difficult. Furthermore, testing of firmware itself may consume large human resources, and may cause a low efficiency.

### SUMMARY OF INVENTION

Embodiment of the present disclosure may provide a method of automatically testing firmware and optimizing a test flow by determining a contextual environment where the firmware may be located; determining a hardware environment where the firmware may be located; and testing the firmware at least partly based on a contextual environment and a hardware environment.

### BRIEF DESCRIPTION OF THE DRAWINGS

The above and other objects, features and advantages of the present disclosure will be made more apparent by describing exemplary embodiments of the present disclosure in more detail with reference to figures, wherein identical reference signs represent identical parts in the exemplary embodiments of the present disclosure.

FIG. 1 illustrates a flowchart of a method 100 for automatically testing a firmware according to an exemplary embodiment of the present disclosure;

FIG. 2 illustrates a flowchart of a method 200 for automatically testing a plurality of firmware according to an exemplary embodiment of the present disclosure;

FIG. 3 illustrates a schematic block diagram of a system 300 for automatically testing a firmware according to an exemplary embodiment of the present disclosure;

FIG. 4 illustrates a schematic block diagram of a system 400 for automatically testing a plurality of firmware according to an exemplary embodiment of the present disclosure;

FIG. 5 illustrates a schematic block diagram of a computer system 500 adapted to practice an embodiment of the present disclosure.

### DETAILED DESCRIPTION OF EMBODIMENTS

Embodiments of the present disclosure will be described in more detail with reference to figures. Although the figures show some embodiments of the present disclosure, it should be appreciated that the present disclosure may be implemented in various forms and should not be limited by embodiments described herein. Instead, these embodiments are provided to make the present disclosure more thorough and complete, and to convey the scope of the present disclosure completely to those skilled in the art.

Embodiment of the present disclosure may provide a method of automatically testing firmware and optimizing a test flow. One embodiment may include determining a contextual environment where a firmware may be located. A further embodiment may include determining a hardware environment where a firmware may be located. A further embodiment may include testing a firmware at least partly based on a contextual environment and a hardware environment.

An alternative embodiment may include testing a firmware at least partly based on a contextual environment and a hardware environment. A further embodiment may include in response to a contextual environment not matching a predetermined contextual environment, guiding a firmware from the contextual environment to a predetermined contextual environment, and may further include performing tests in a predetermined contextual environment.

In an alternative embodiment may include testing a firmware at least partly based on a contextual environment and a hardware environment. A further embodiment may include modifying a test case for a test according to a hardware environment; and may further include testing the firmware by at least using a modified test case.

An alternative embodiment may include a hardware environment comprising a hardware structure and a hardware interface, wherein the hardware structure may be abstracted to form a code for describing hardware structure properties, and may further include a hardware interface that may be abstracted to form a code for describing communication via the hardware interface.

An alternative embodiment may include the hardware structure being abstracted. A further embodiment may include abstracting hardware structure properties related to a test and not abstracting hardware structure properties not related to a test.

Embodiment of the present disclosure may provide a method for automatically testing a plurality of firmware. A further embodiment may include assigning a priority level for each of the plurality of firmware. A further embodiment may include determining a testing order for the plurality of firmware at least partly based on the priority levels. A further embodiment may include executing the method according to any aforesaid embodiment for each of the plurality of firmware according to the testing order.

An alternative embodiment may include determining arrival time for a testing task of each of the plurality of firmware, wherein the testing order may be further determined based on the arrival time.

An alternative embodiment may include for a current firmware to be tested among the plurality of firmware, determining whether a current firmware to be tested may have already entered a tested state. A further embodiment may include starting a test in response to a firmware having already entered a tested state.

An alternative embodiment may include in response to a current firmware to be tested not having yet entered a tested state, skipping a current firmware to be tested. A further embodiment may include determining whether a next firmware to be tested according to a testing order may have already entered a tested state.

An alternative embodiment may include testing being performed concurrently for a plurality of different tested platform types or a plurality of firmware to be tested under a same tested platform type.

Embodiment of the present disclosure may provide a system for automatically testing a firmware. A further embodiment may include a context determining unit that may be configured to determine a contextual environment where a firmware is located. A further embodiment may include a hardware determining unit that may be configured to determine a hardware environment where a firmware is located. A further embodiment may include a testing unit that may be configured to test a firmware at least partly based on a contextual environment and a hardware environment.

An alternative embodiment may include a testing unit that may further include a guiding unit that may be configured to, in response to the contextual environment not matching a predetermined contextual environment, guide a firmware from this contextual environment to the predetermined contextual environment. In a further embodiment, a testing unit may further include a first sub-testing unit that may be configured to perform test in a predetermined contextual environment.

In an alternative embodiment a testing may include a modifying unit that may be configured to modify a test case for a test according to a hardware environment. In an alternate embodiment a testing unit may include a second sub-testing unit that may be configured to test a firmware by at least using a modified test case.

In an alternative embodiment a hardware environment may include a hardware structure and a hardware interface, wherein the hardware structure may be abstracted to form a code for describing hardware structure properties, and the hardware interface may be abstracted to form a code for describing communication via the hardware interface.

In an alternative embodiment the hardware structure may be abstracted. A further embodiment may include abstracting a hardware structure properties related to a test and not abstracting a hardware structure properties not related to a test.

Embodiment of the present disclosure may provide a system for automatically testing a plurality of firmware. A further embodiment may include a priority level assigning unit that may be configured to assign a priority level for each of the plurality of firmware. A further embodiment may include an order determining unit that may be configured to determine a testing order for a plurality of firmware at least partly based on priority levels. A further embodiment may include an executing unit that may be configured to execute a method for each of a plurality of firmware according to a testing order.

An alternative embodiment may include a system that may further include an arrival time determining unit that may be configured to determine an arrival time for a testing task of each of a plurality of firmware, wherein the order determining unit may be further configured to determine a testing order based on an arrival time.

An alternate embodiment may include a system that may further include a state determining unit that may be configured to—for a current firmware to be tested among a plurality of firmware, determine whether a current firmware to be tested may have already entered a tested state. A further embodiment may include a testing unit that may be configured to start a test in response to a firmware having already entered the tested state.

An alternative embodiment may include a testing unit that may be further configured to skip a current firmware to be tested in response to a current firmware to be tested that may not have yet entered the tested state. A further embodiment may include a testing unit that may be enabled to determine whether next firmware to be tested according to a testing order may already have entered a tested state.

An alternative embodiment may include testing that may be performed concurrently for a plurality of different tested platform types or a plurality of firmware to be tested under a same tested platform type.

According to embodiments of the present disclosure, automatic testing of a firmware may be achieved automatically in a case that an actual software and hardware configuration of a tested system cannot be predicted in advance, thereby saving human resources and improving testing efficiency.

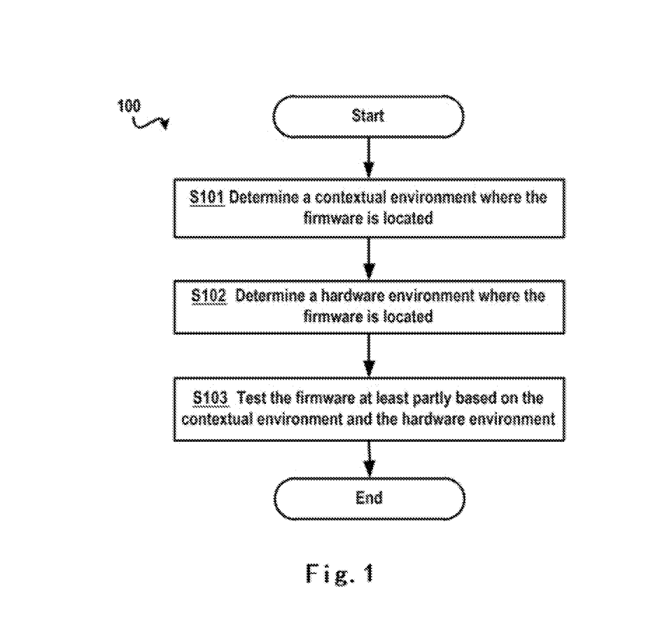

FIG. 1 illustrates a flowchart of a method 100 for automatically testing firmware according to an exemplary embodiment of the present disclosure. As shown in the figure, after method 100 starts, flow proceeds to step S101 of determining a contextual environment where the firmware is located. Method 100 proceeds to step S102 of determining a hardware environment where the firmware is located. method 100 proceeds to step S103 of testing the firmware at least partly based on the contextual environment and the hardware environment. Method 100 ends.

In one embodiment, noticeably, a so-called “contextual environment” in a text may refer to “software environment” relative to hardware environment, namely, a “state” of a tested system (hereinafter referred to as “tested system”) where a firmware may be located. In a further embodiment, before a task of testing a firmware may begin, first a contextual environment where a firmware may be located needs to be learnt about. In a further embodiment, a contextual environment includes but may not be limited to WINDOWS operating system, LINUX operating system, POST, PXE operating system, Debugger, BIOS, etc.

In one embodiment, as stated above, a “hardware environment” here may be relative to a “contextual environment” (namely, “software environment”). In a further embodiment, for example, a hardware environment may include an actual hardware configuration of a tested system. In one embodiment of implementation, behavior priori knowledge of a tested system in a specific state may be used to detect the tested system, and an actual hardware configuration may be determined according to the detection result. In a further embodiment, the term “priori knowledge” may include but may not be limited to hardware configuration information of a tested system acquired through historical behaviors.

According to one embodiment of implementation of the present disclosure, step S103 may include, in response to a contextual environment determined in step S101 not matching a predetermined contextual environment (namely, a target contextual environment), guiding a firmware from this contextual environment to a predetermined contextual environment. In a further embodiment, those skilled in the art may understand that during a test, a tested system may be guided to a target system state according to a test purpose. In a further embodiment quality of a firmware may be judged by detecting a matching degree of behavior of a tested system in a target system state and an expected result. In one embodiment, however, the present disclosure may not necessarily be limited to this. In one embodiment, according to another implementation of the present disclosure, step S103 may also include modifying a test case for this test according to a hardware environment determined in step S102. A further embodiment may include testing firmware by at least using a modified test case. In one embodiment, for example, in an implementation, a test case might include testing fragments for various hardware components in a hardware environment, whereupon relevant testing fragments of the hardware components not involved in a current hardware environment may be clipped according to detection of a hardware environment of a tested system so as to achieve an effect of saving resources.

According to an embodiment of the present disclosure, a hardware environment may include a hardware structure and a hardware interface. In a further embodiment, in practice, relevant hardware may be abstracted based on an idea of “object-orientated programming” so as to implement testing of a firmware. In a further embodiment, for example, a hardware structure may be abstracted to form a code for describing hardware structure properties. In a further embodiment, as an example, a hardware structure may be abstracted as a tree-like structure of software. In a further embodiment, with a hardware structure being abstracted, a code can be used to describe a hardware configuration so as to facilitate regulation of a function of hardware by setting a code instruction. In a further alternative embodiment, only hardware structure properties related to hardware testing may be abstracted, without abstracting hardware structure properties irrelevant to a firmware testing and thereby further saving resources and improving the efficiency of firmware testing.

In an alternate or additionally, a hardware interface may be abstracted to form a code for describing communication via a hardware interface. In one embodiment, in practice, communication with a tested system is usually via various communication protocols, for example, serial interface or LAN. In a further embodiment, with a hardware interface being abstracted, a code may be used to describe a communication via an interface so as to facilitate planning and definition of interface-related functions by setting a code instruction.

In one embodiment, noticeably, according to an abstraction of a hardware structure and hardware interface of a tested system, it may be possible to collect properties and behaviors of the tested system responsive to specific setting by setting a related instruction, so as to dynamically update priori knowledge of a tested system during a test. In a further embodiment, these updated priori knowledge may in turn be used to more accurately determine a hardware environment of a tested system as stated above.

In a further embodiment, as can be seen from the above, by introducing specific consideration of a contextual environment and hardware environment where a firmware may be located, method 100 may automatically implement automatic testing of a firmware in a case that an actual software and hardware configuration of a tested system may not be predicted in advance, thereby saving human resources and improving the testing efficiency.

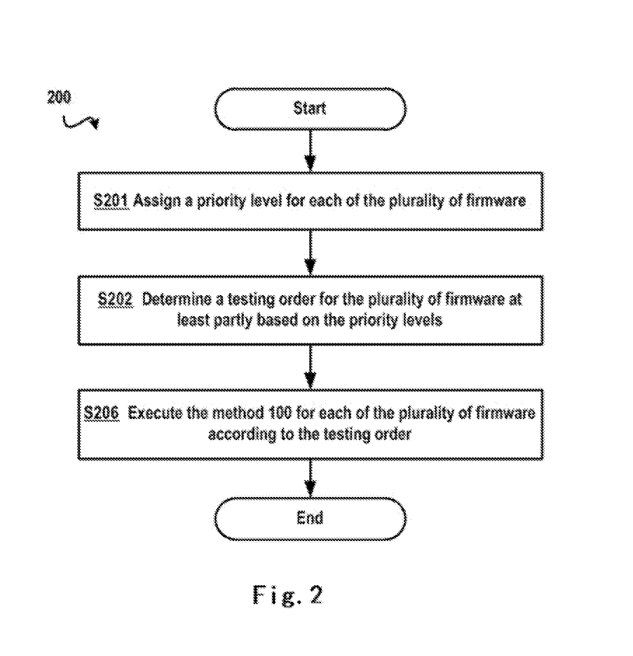

FIG. 2 illustrates a flowchart of a method 200 for automatically testing a plurality of firmware according to an exemplary embodiment of the present disclosure.

As shown in FIG. 2, after the method 200 starts, flow proceeds to step S201 of assigning a priority level for each of the plurality of firmware. Method 200 proceeds to step S202 of determining a testing order for the plurality of firmware at least partly based on the priority levels. Method 200 proceeds to step S206 of executing steps of the method described above with reference to the method 100 for each of the plurality of firmware according to the testing order. Method 200 ends.

In one embodiment, in a case that a plurality of firmware needs to be tested (namely, there exist a plurality of testing tasks for a plurality of firmware), a scheduling of tasks of testing firmware may be coordinated in a way of assigning a testing priority level for each firmware.

In one embodiment, for example, when task scheduling may be performed, testing tasks with higher priority levels may be prioritized. In a further embodiment, however, the present disclosure is not limited to this; and other factors may be used to help determine a testing order of a plurality of firmware. In one embodiment, for example, arrival time may also be determined for a testing task of each of a plurality of firmware, and a testing order of a plurality of firmware may be further determined based on an arrival time.

According to an embodiment of the present disclosure, a plurality of states may be set for each developed firmware. In a further embodiment, for example, “firmware development state”, “ready-for-test state” and “tested state”, wherein “firmware development state” may indicate that a firmware may be in the process of development and not ready for testing. In a further embodiment, upon completion of development, an exit sign (e.g., “firmware available”) may be set for a “firmware development state” that may indicate exiting of a firmware development state and may meanwhile indicate an access to “ready-for-test state”. In a further embodiment, “ready-for-test state” may indicate that a firmware is in a state in which a development of the firmware has been completed and a testing request may not yet have been sent for some reasons.

According to one embodiment, in a “ready-for-test state”, a test priority level involved in step S201 may be assigned to each task. In a further embodiment, once a testing request is sent, a firmware may be in the “tested state”, whereupon various relevant steps of methods involved in methods 100 and 200 may be performed on the firmware. In one embodiment, considering an implementation, various states such as “development state”, “ready-for-test state” and “tested state” may be recorded in a file for inquiry. In another embodiment, a file may be used additionally to record other information such as priority level information involved in for example step S201. In a further embodiment, method 200 may, optionally include, for a current firmware to be tested among a plurality of firmware, determining whether it may already have entered a tested state, and performing a test in response to a firmware having already entered a tested state. In another embodiment, alternatively, a current firmware to be tested may be skipped in response to a current firmware to be tested having not yet entered a tested state (for example, in a “development state” or “ready-for-test state”), and determining whether a next firmware to be tested according to a testing order may already have entered a tested state. In a further embodiment, as such, when a firmware originally closer to a top of a testing order may not be ready for test, the method may not stop here, and may instead attempt to test a next firmware.

In addition, in another embodiment, testing may be performed concurrently for a plurality of different tested platform types or a plurality of firmware to be tested under a same tested platform type. In an exemplary embodiment of implementation, a plurality of tests performed concurrently may be presented in one testing interface.

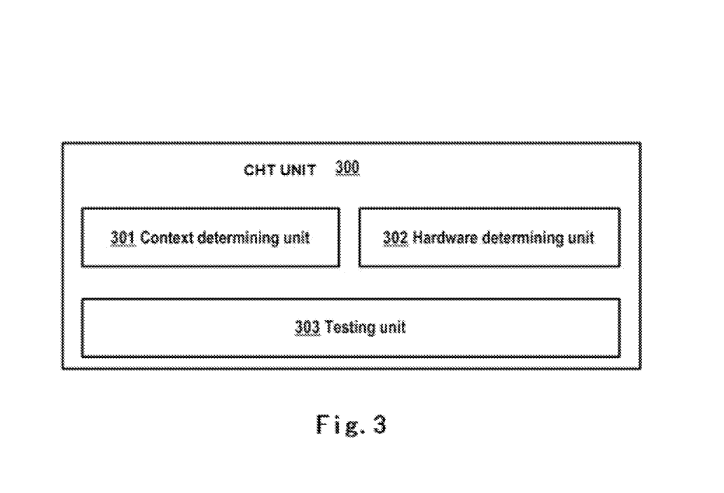

Reference is now made to a system 300 for automatically testing a firmware according to an exemplary embodiment of the present invention as shown in FIG. 3.

As shown in FIG. 3, system 300 (CHT Unit) comprises context determining unit 301 configured to determine a contextual environment where the firmware is located; hardware determining unit 302 configured to determine a hardware environment where the firmware is located; and testing unit 303 configured to test the firmware at least partly based on the contextual environment and the hardware environment. In one embodiment, a single CHT unit 300 may perform the tasks of each of the sub-units.

In an alternative embodiment, testing unit 303 may include a guiding unit that may be configured to, in response to a contextual environment not matching a predetermined contextual environment, guide a firmware from the contextual environment to the predetermined contextual environment; and a first sub-testing unit that may be configured to perform test in a predetermined contextual environment.

In an alternative embodiment, testing unit 303 may include a modifying unit that may be configured to modify a test case for a test according to a hardware environment; and a second sub-testing unit that may be configured to test a firmware by at least using a modified test case.

In an alternative embodiment, a hardware environment may include a hardware structure and a hardware interface, wherein the hardware structure may be abstracted to form a code for describing hardware structure properties, and the hardware interface may be abstracted to form a code for describing communication via a hardware interface.

In an alternative embodiment, a hardware structure being abstracted may include abstracting hardware structure properties that may be related to a test and not abstracting hardware structure properties that may not be related to a test.

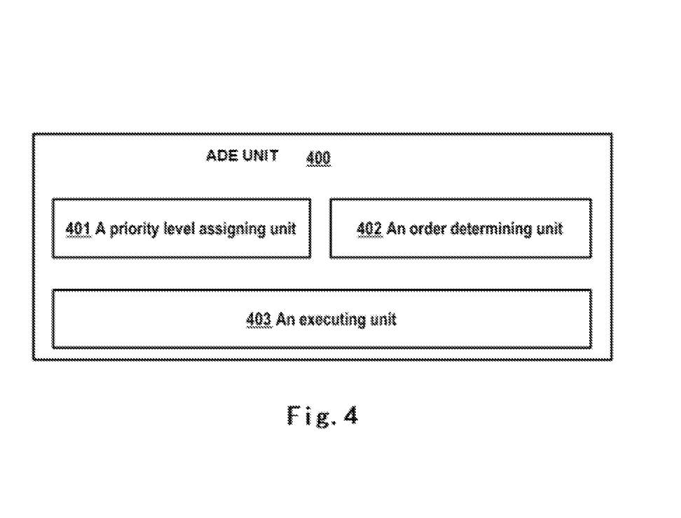

FIG. 4 further illustrates system 400 (ADE Unit) of automatically testing a plurality of firmware according to an exemplary embodiment of the present disclosure. As shown in the figure, system 400 comprises priority level assigning unit 401 configured to assign a priority level for each of the plurality of firmware; order determining unit 402 configured to determine a testing order for the plurality of firmware at least partly based on the priority levels; and executing unit 403 configured to execute the method according to any relevant solution in the aforesaid method 100 and method 200 for each of the plurality of firmware according to the testing order. In one embodiment, a single ADE unit 400 may be configured to perform the tasks associated with each of the sub-units.

In an alternative embodiment, system 400 may further include an arrival time determining unit configured to determine an arrival time for a testing task of each of a plurality of firmware, wherein an order determining unit 402 may be further configured to determine a testing order based on an arrival time.

In an alternative embodiment, testing unit 303 in system 300 may be further configured to skip a current firmware to be tested in response to the current firmware to be tested having not yet entered a tested state, and determine whether a next firmware to be tested according to a testing order may already have entered a tested state.

In an alternative embodiment, testing may be performed concurrently for a plurality of different tested platform types or a plurality of firmware to be tested under the same tested platform type.

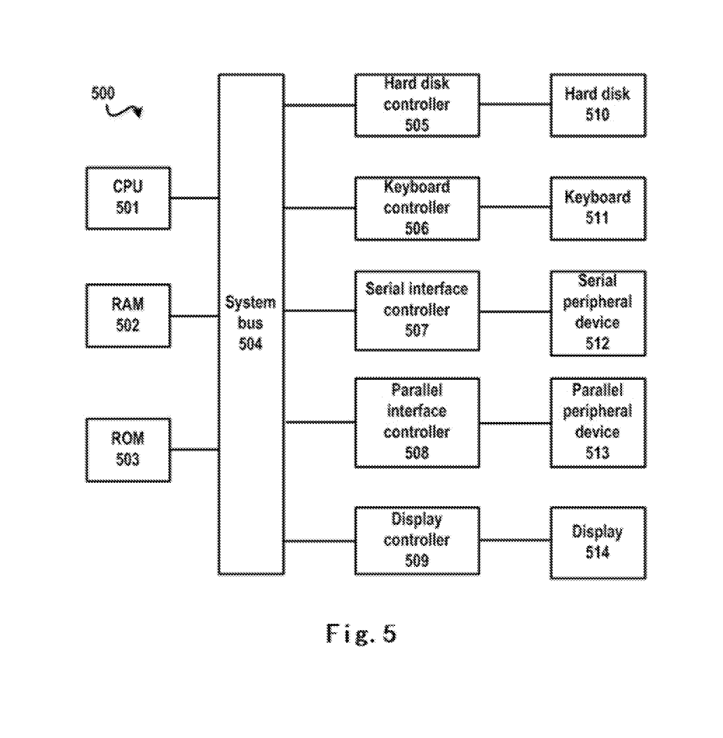

Reference is now made to FIG. 5, which illustrates a schematic block diagram of computer system 500 adapted to practice an embodiment of the present disclosure. For example, computer system 500 shown in FIG. 5 may be used to implement parts of system 300 and apparatus 400 for determining application correctness as described above, and also used to solidify or implement steps of the method 200 for determining application correctness as depicted above.

As shown in FIG. 5, the computer system as shown in the figure includes CPU (Central Processing Unit) 501, RAM (Random Access Memory) 502, ROM (Read Only Memory) 503, system bus 505, hard disk controller 505, keyboard controller 506, serial interface controller 507, parallel interface controller 508, display controller 509, hard disk 510, keyboard 511, serial peripheral device 512, parallel peripheral device 513 and display 514. Among these components, coupled to system bus 505 are CPU 501, RAM 502, ROM 503, hard disk controller 505, keyboard controller 506, serial interface controller 507, parallel interface controller 508 and display controller 509. Hard disk 510 is coupled to hard disk controller 505; keyboard 511 is coupled to keyboard controller 506; serial peripheral device 512 is coupled to serial interface controller 507; parallel peripheral device 513 is coupled to parallel interface controller 508; and display 514 is coupled to display controller 509. It should be understood that the structural block diagram in FIG. 5 is shown only for illustration purpose, and is not intended to limit the scope of the present invention. In some cases, some devices may be added or reduced depending on specific situations.

As stated above, system 300 may be implemented as a pure hardware, e.g., a chip, ASIC, SOC or the like. This hardware may be integrated in computer system 500. Besides, embodiments of the present disclosure may be implemented in the manner of a computer program product. For example, method 100 as described with reference to FIG. 1 or method 200 as described with reference to FIG. 2 may be implemented via a computer program product. This computer program product may be stored in RAM 502, ROM 504, hard disk 510 and/or any suitable storage medium as illustrated in FIG. 5, or downloaded to computer system 500 from a suitable location in the network. The computer program product may comprise a computer code portion comprising program instructions that may be executed by a suitable processing device (for example, CPU 501 shown in FIG. 5). The program instructions may at least comprise instructions for implementing steps of method 100 and/or method 200. These program instructions may at least comprise: an instruction for determining a contextual environment where the firmware is located; an instruction for determining a hardware environment where the firmware is located; and an instruction for testing the firmware at least partly based on the contextual environment and the hardware environment.

The preceding text has already illustrated the spirit and principles of the present disclosure in conjunction with several embodiments. The method and system for automatically testing firmware according to the present disclosure have many advantages over the prior art. For example, the present disclosure supports automated implementation of firmware testing by providing a suitable method and system. With the embodiments provided by the present disclosure, automatic testing of the firmware may be achieved automatically in the case that the actual software and hardware configuration of the tested system cannot be predicted in advance, thereby saving human resources and improving the testing efficiency.

It should be noted that, the embodiments of the present disclosure can be implemented in software, hardware or the combination thereof. The hardware part can be implemented by a special logic; the software part can be stored in a memory and executed by a proper instruction execution system such as a microprocessor or a design-specific hardware. The normally skilled in the art may understand that the above method and system may be implemented with a computer-executable instruction and/or in a processor controlled code, for example, such code is provided on a carrier medium such as a magnetic disk, CD, or DVD-ROM, or a programmable memory such as a read-only memory (firmware) or a data carrier such as an optical or electronic signal carrier. The apparatuses and their modules in the present disclosure may be implemented by hardware circuitry of a programmable hardware device such as a very large scale integrated circuit or gate array, a semiconductor such as logical chip or transistor, or a field-programmable gate array, or a programmable logical device, or implemented by software executed by various types of processors, or implemented by combination of the above hardware circuitry and software.

It should be noted that although a plurality of means or sub-means of the device have been mentioned in the above detailed depiction, such partitioning is merely non-compulsory. In actuality, according to the embodiments of the present disclosure, the features and functions of the above described two or more means may be embodied in one means. In turn, the features and functions of the above described one means may be further embodied in more modules.

Besides, although operations of the present method are described in a particular order in the drawings, it does not require or imply that these operations must be performed according to this particular sequence, or a desired outcome can only be achieved by performing all shown operations. Instead, the execution order for the steps as depicted in the flowcharts may be varied. Additionally or alternatively, some steps may be omitted, a plurality of steps may be merged into one step, and/or a step may be divided into a plurality of steps for execution.

Although the present disclosure has been depicted with reference to a plurality of embodiments, it should be understood that the present disclosure is not limited to the disclosed embodiments. The present disclosure intends to cover various modifications and equivalent arrangements included in the spirit and scope of the appended claims. The scope of the appended claims meets the broadest explanations and covers all such modifications and equivalent structures and functions.

What is claimed is:

1. A method for automatically testing a firmware, the method comprising:
determining a contextual environment where a firmware is located;
determining a hardware environment where the firmware is located; and
testing the firmware at least partly based on the contextual environment and the hardware environment.

2. The method according to claim 1, wherein testing the firmware at least partly based on the contextual environment and the hardware environment further comprises:
in response to the contextual environment not matching a predetermined contextual environment, guiding the firmware from the contextual environment to the predetermined contextual environment; and
performing tests on the firmware in the predetermined contextual environment.

3. The method according to claim 1, wherein testing the firmware at least partly based on the contextual environment and the hardware environment further comprises:
modifying a test case to create a modified test case for the test according to the hardware environment; and
testing the firmware by at least using the modified test case.

4. The method according to claim 1, wherein the hardware environment includes a hardware structure and a hardware interface, wherein the hardware structure is abstracted to form a code for describing hardware structure properties, and the hardware interface is abstracted to form a code for describing communication via the hardware interface.

5. The method according to claim 4, wherein the hardware structure being abstracted further comprises:
abstracting the hardware structure properties related to the test and not abstracting the hardware structure properties not related to the test.

6. A method for automatically testing a plurality of firmware, the method comprising:
assigning a priority level for each of a plurality of firmware;
determining a testing order for the plurality of firmware at least partly based on the priority levels; and
according to the testing order, executing for each of the plurality of firmware
determining a contextual environment where a firmware is located;
determining a hardware environment where the firmware is located; and
testing the firmware at least partly based on the contextual environment and the hardware environment.

7. The method according to claim 6, further comprising:
determining an arrival time for a testing task of each of the plurality of firmware, wherein the testing order is further determined based on the arrival time.

8. The method according to claim 6, further comprising:
for a current firmware to be tested among the plurality of firmware, determining whether the current firmware to be tested has already entered a tested state, and
starting the test in response to the firmware having already entered the tested state.

9. The method according to claim 8, further comprising:
in response to the current firmware to be tested having not yet entered the tested state, skipping the current firmware to be tested, and determining whether next firmware to be tested according to the testing order has already entered a tested state.

10. The method according to claim 6, wherein the test is performed concurrently for a plurality of different tested platform types or a plurality of firmware to be tested under the same tested platform type.

11. A system for automatically testing a firmware, the system configured to determine a contextual environment where the firmware is located;
determine a hardware environment where the firmware is located; and
test the firmware at least partly based on the contextual environment and the hardware environment.

12. The system according to claim 11, further configured to:
in response to the contextual environment not matching a predetermined contextual environment, guide the firmware from this contextual environment to the predetermined contextual environment, and
perform test on the firmware in the predetermined contextual environment.

13. The system according to claim 11, further configured to
modify a test case to create a modified test case for the test according to the hardware environment; and
test the firmware by at least using the modified test case.

14. The system according to claim 11, wherein the hardware environment includes a hardware structure and a hardware interface, wherein the hardware structure is abstracted to form a code for describing hardware structure properties, and the hardware interface is abstracted to form a code for describing communication via the hardware interface.

15. The system according to claim 14, wherein the hardware structure being abstracted comprises:
abstracting the hardware structure properties related to the test and not abstracting the hardware structure properties not related to the test.
